(19) United States
(12) Patent Application Publication
(10) Pub. No.: US 2026/0331448 A1
(43) Pub. Date: Oct. 22, 2026

(54) MASS SPECTROMETER

(71) Applicant: SHIMADZU CORPORATION, Kyoto-shi, Kyoto (JP)

(72) Inventors: Kenta TERASHIMA, Kyoto-shi (JP); Satoshi KASAMATSU, Kyoto-shi (JP)

(73) Assignee: SHIMADZU CORPORATION, Kyoto-shi, Kyoto (JP)

(21) Appl. No.: 19/122,073

(22) PCT Filed: Sep. 7, 2023
(86) PCT No.: PCT/JP2023/032730

§ 371 Date: Apr. 17, 2025

(30) Foreign Application Priority Data
Nov. 10, 2022 (JP) 2022-180132

(51) Int. Cl. H01J 49/10; H01J 49/16; H01J 49/24

(52) U.S. Cl. CPC H01J 49/107; H01J 49/164; H01J 49/167; H01J 49/24

(57) ABSTRACT

A mass spectrometer in which first and second ion sources are alternatively attached as an ionization section, includes: a mass spectrometry section in a vacuum chamber connected to the ionization section via a partition wall for separating and detect ions according to a mass-to-charge ratio; a first ion introduction pipe to penetrate the partition wall for introducing the ions into the vacuum chamber, the first ion introduction pipe being used when the first ion source is used; a second ion introduction pipe to penetrate the partition wall for introducing the ions into the vacuum chamber, the second ion introduction pipe being longer than the first ion introduction pipe, and being used when the second ion source is used; and a heating unit to heat a portion of the second ion introduction pipe, the portion being located closer to the ionization section than the first ion introduction pipe.

### CROSS REFERENCE TO RELATED APPLICATIONS

This application is a National Stage of International Application No. PCT/JP 2023/032730 filed Sep. 7, 2023, claiming priority based on Japanese Patent Application No. 2022-180132 filed Nov. 10, 2022.

### TECHNICAL FIELD

The present invention relates to a mass spectrometer using an ion source that generates ions by irradiating a sample with laser light in an atmospheric pressure.

### BACKGROUND ART

In order to identify and quantify a target substance contained in a liquid sample, a mass spectrometer including an ionization section that generates ions of the target substance by electrospray ionization (ESI) is used. In ESI, a liquid sample is charged and sprayed into an ionization chamber having substantially atmospheric pressure and ionized, and ions are introduced into a mass spectrometry section in a vacuum chamber via an ion introduction pipe. The ion introduction pipe is disposed so as to penetrate a partition wall between the ionization chamber and the vacuum chamber, and the ion introduction pipe is heated to promote desolvation of ions, whereby the ion generation efficiency is increased.

In addition, in order to measure a target substance contained in a biological sample or the like, mass spectrometry using a mass spectrometer equipped with a Matrix-Assisted Laser Desorption/Ionization (MALDI) source is performed (for example, Patent Literature 1). The MALDI source is an ion source that ionizes the sample by MALDI method.

The MALDI source includes an atmospheric pressure MALDI source for ionizing a sample in the atmospheric pressure, and a vacuum MALDI source for ionizing a sample in vacuum. A mass spectrometer having the atmospheric pressure MALDI includes an ionization section of atmospheric pressure (an atmospheric pressure MALDI source), and a mass spectrometry section which is provided in a vacuum chamber and separates and detects ions according to a mass-to-charge ratio.

In the mass spectrometer including the atmospheric pressure MALDI source, mass spectrometry is performed as follows.

First, a pretreatment is performed, in which a matrix substance, which is an easily ionized substance, is applied onto a surface of the sample placed on a sample plate, whereby microcrystals of the matrix substance incorporating molecules of the sample are formed on the surface of the sample. When the sample plate on which the pretreated sample is placed is set at a predetermined position of the MALDI source, and the sample surface is irradiated with laser light, the microcrystals of the matrix substance present on the surface are heated, and the sample molecules in the microcrystals are detached from the surface and are ionized.

Ions thus generated from the sample molecules are taken in from an inlet end (ion intake port) of the ion introduction pipe, and enter the mass spectrometry section through the ion introduction pipe. The ions that have entered the mass spectrometry section are separated according to the mass-to-charge ratio and detected by an ion detector. By plotting the signal intensity sequentially output from the ion detector with the mass-to-charge ratio of the ions, a mass spectrum in which the horizontal axis is the mass-to-charge ratio and the vertical axis is the signal intensity is obtained.

The ESI source and the atmospheric pressure MALDI source are different in their ionization method, but a common mass spectrometry section can be used for these ion sources. However, in the atmospheric pressure MALDI source, a mirror for reflecting light irradiating the sample surface, a lens for condensing light, and other gadgets are disposed. Therefore, the sample is usually located farther from the vacuum chamber in the atmospheric pressure MALDI source than in the ESI source.

### CITATION LIST

### Patent Literature

Patent Literature 1: JP 2021-196303 A

### Non Patent Literature

Non Patent Literature 1:“Imaging One-Stop Application-from physical property evaluation of administered drug to metabolomics by distribution/quantification of drug and metabolite-”, [online], Shimadzu Corporation, [searched on September 7, 2023], Internet

### SUMMARY OF INVENTION

### Technical Problem

When an ion introduction pipe for the ESI source is used as it is in use of the atmospheric pressure MALDI, the distance from the sample to the inlet of the ion introduction pipe is longer in the atmospheric pressure MALDI source, and the efficiency of taking ions into the ion introduction pipe deteriorates. Therefore, when generating ions by the atmospheric pressure MALDI source, the inlet end of the ion introduction pipe is located in the vicinity of a measurement point by, for example, adding an extension pipe to the ion introduction pipe for the ESI source. However, it has been found that when ions generated by the atmospheric pressure MALDI source are introduced into the vacuum chamber with the elongated, by adding for example an extension pipe, ion introduction pipe for the ESI source, ions cannot be measured with sufficient sensitivity in some cases.

An object of the present invention is to improve ion measurement sensitivity in a mass spectrometer using an ion source that generates ions by irradiating a sample with laser light in an atmospheric pressure.

### Solution to Problem

The present invention made to solve the above-described problem is a mass spectrometer in which a first ion source configured to spray and ionize a liquid sample in an atmospheric pressure and a second ion source configured to irradiate a sample with laser light and ionize the sample in an atmospheric pressure are alternatively attached as an ionization section, the mass spectrometer including:
a mass spectrometry section which is provided in a vacuum chamber connected to the ionization section via a partition wall and is configured to separate and detect ions generated in the ionization section according to a mass-to-charge ratio;
a first ion introduction pipe which is provided to penetrate the partition wall and is configured to introduce the ions generated in the ionization section into the vacuum chamber, the first ion introduction pipe being used when the first ion source is used;
a second ion introduction pipe which is provided to penetrate the partition wall and is configured to introduce the ions generated in the ionization section into the vacuum chamber, the second ion introduction pipe being longer than the first ion introduction pipe, and being used when the second ion source is used; and
a heating unit configured to heat a portion of the second ion introduction pipe, the portion being located closer to the ionization section than the first ion introduction pipe.

### Advantageous Effects of Invention

The above-described first ion source which sprays and ionizes the liquid sample is, for example, an ESI source, an atmospheric pressure chemical ionization (APCI) source, or a dual ion source (DUIS) including both the ESI source and the APCI source. The above-described second ion source which irradiates a sample with laser light and ionizes the sample in the atmospheric pressure is, for example, an atmospheric pressure MALDI source or a surface-assisted laser desorption/ionization (SALDI) source.

When the ion introduction pipe used in the ESI source or the APCI source is used as it is in using the atmospheric pressure MALDI source or the like, the distance from the inlet end of the ion introduction pipe to the measurement point is longer, and the efficiency of taking ions into the ion introduction pipe deteriorates. Therefore, in the present invention, when the second ion source is used, a second ion introduction pipe which is longer than a first ion introduction pipe used when the first ion source is used is used. According to findings obtained by the present inventors, conventionally, the reason why ions cannot be measured with sufficient sensitivity when using the second ion introduction pipe is that a portion of the second ion introduction pipe, the portion being located closer to the ionization section than the first ion introduction pipe, is not heated and is at low temperature. In the mass spectrometer according to the present invention, a portion of the second ion introduction pipe, the portion being located closer to the ionization section than the first ion introduction pipe, is heated by the heating unit, so that the ion measurement sensitivity can be improved as compared with the conventional measurement.

### BRIEF DESCRIPTION OF DRAWINGS

FIG. 1 A configuration diagram of a main part of an embodiment of a mass spectrometer according to the present invention.

FIG. 2 A schematic diagram of a sample introduction unit of the mass spectrometer of the present embodiment (when an ESI source is used).

FIG. 3 A schematic diagram of the sample introduction unit of the mass spectrometer of the present embodiment (when an atmospheric pressure MALDI source is used).

FIG. 4 A configuration example of the sample introduction unit of the mass spectrometer of the present embodiment (when the atmospheric pressure MALDI source is used).

FIG. 5 A diagram illustrating a detachable portion of the sample introduction unit of the mass spectrometer of the present embodiment (when the atmospheric pressure MALDI source is used).

FIG. 6 Results of measuring temperatures of a second ion introduction pipe in Comparative Example and Example.

FIG. 7 Results of measuring ion intensities of AngII and Chloroquine in Comparative Example and Example.

FIG. 8 Results of measuring ion intensities derived from a mouse brain under conditions of different heating temperatures at a tip in Example.

### DESCRIPTION OF EMBODIMENTS

One embodiment of a mass spectrometer according to the present invention will be described below with reference to the drawings.

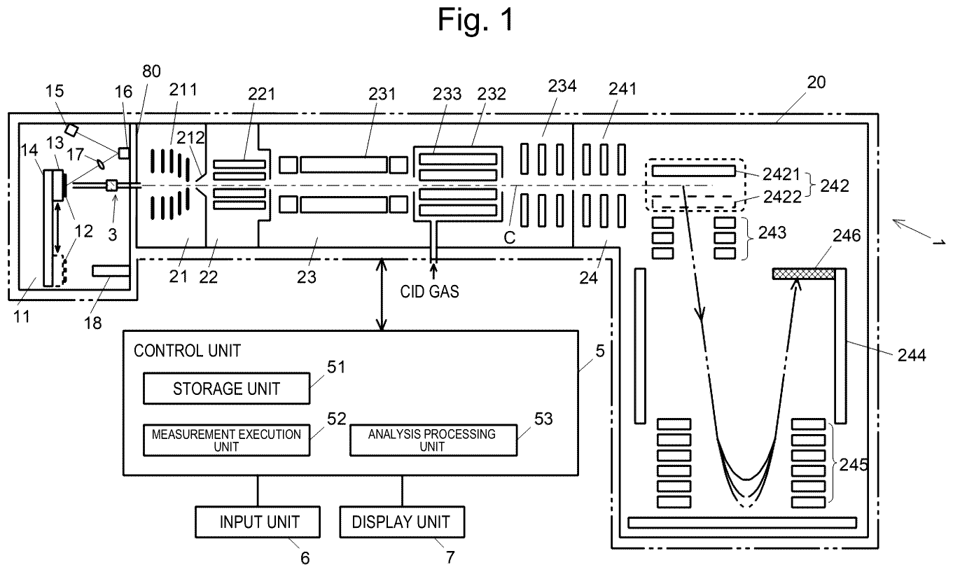

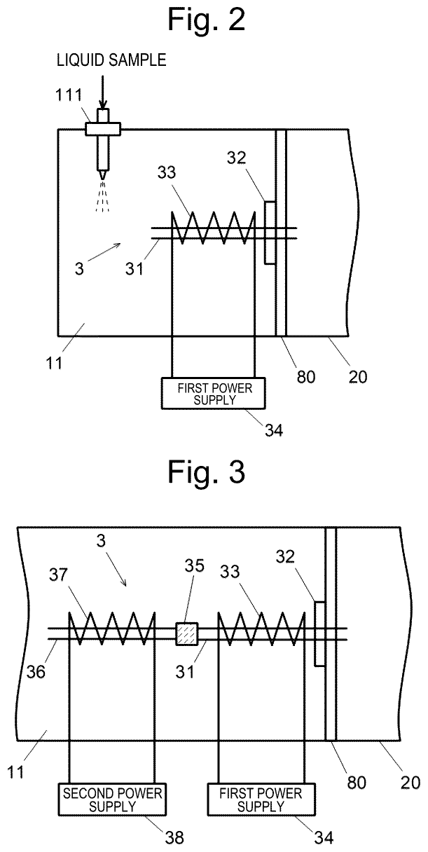

FIG. 1 illustrates an entire configuration of a main part of a mass spectrometer 1 of the present embodiment (when an atmospheric pressure MALDI source is used). The mass spectrometer 1 of the present embodiment includes an ionization section having the atmospheric pressure MALDI source provided in an ionization chamber 11 having substantially atmospheric pressure and a mass spectrometry section which is provided in a vacuum chamber 20 and separates and detects ions according to a mass-to-charge ratio. In addition, in the mass spectrometer 1 of the present embodiment, an ESI source (see FIG. 2) which sprays and ionizes (electrospray-ionizes) a liquid sample in the same atmospheric pressure can be used instead of the atmospheric pressure MALDI source.

The atmospheric pressure MALDI source includes a sample plate holder 13 on which a sample plate 12 is placed, and a moving mechanism 14 which moves the sample plate 12 between an observation position (a position indicated by a broken line in FIG. 1) and a measurement position (a position indicated by a solid line in FIG. 1). In addition, an optical system such as a laser light source 15, a mirror 16 which reflects light emitted from the laser light source 15 and irradiates the sample plate 12 placed on the sample plate holder 13 with the light, and a lens 17 which condenses the laser light reflected by the mirror 16 on a measurement point on the sample plate is provided. In addition, an optical microscope 18 for observing a surface of a sample on the sample plate 12 is provided.

A partition wall 80 is provided between the atmospheric pressure MALDI source and the vacuum chamber 20, and a sample introduction unit 3 is provided in the partition wall 80. Details of the sample introduction unit 3 will be described later.

In the vacuum chamber 20, a first intermediate vacuum chamber 21, a second intermediate vacuum chamber 22, a third intermediate vacuum chamber 23, and an analysis chamber 24 are provided in this order from the ionization chamber 11 side. Each of these chambers has a configuration of a multi-stage differential exhaust system in which the degree of vacuum gradually increases from the first intermediate vacuum chamber 21 toward the analysis chamber 24.

In the first intermediate vacuum chamber 21, there is disposed an ion lens 211 including a plurality of ring electrodes, for transporting ions generated in the ionization chamber 11 and introduced through the sample introduction unit 3 to the subsequent stage while converging the ions in the vicinity of an ion optical axis C which is a central axis of a flight direction of the ions.

The first intermediate vacuum chamber 21 and the second intermediate vacuum chamber 22 are separated from each other by a skimmer 212 having a small hole at its top. Also in the second intermediate vacuum chamber 22, an ion guide 221 including a plurality of rod electrodes, for transporting the ions to the subsequent stage while converging the ions in the vicinity of the ion optical axis C, is disposed.

The second intermediate vacuum chamber 22 and the third intermediate vacuum chamber 23 communicate with each other through a small-diameter hole provided in the partition wall provided between them. In the third intermediate vacuum chamber 23, a quadrupole mass filter 231 including four rod electrodes, a collision cell 232, and an ion lens 234 including a plurality of ring electrodes are disposed in this order from the side closer to the second intermediate vacuum chamber 22. A multipole ion guide 233 including a plurality of rod electrodes is disposed inside the collision cell 232. A CID gas, such as argon or nitrogen, is continuously or intermittently supplied into the collision cell 232 at appropriate timing.

The third intermediate vacuum chamber 23 and the analysis chamber 24 communicate with each other through a small-diameter hole provided in the partition wall between them. In the analysis chamber 24, an ion lens 241 including a plurality of ring electrodes, an orthogonal acceleration unit 242, an acceleration electrode 243, a flight tube 244, a reflectron electrode 245, and an ion detector 246 are disposed. The orthogonal acceleration unit 242 includes an expulsion electrode 2421 and an attraction electrode 2422, which are disposed to face each other with a flight path interposed between them of the ions transported by the ion lens 241 and each of which is a plate-like electrode. At the attraction electrode 2422, an opening which allows ions to pass through is provided. The acceleration electrode 243 includes a plurality of ring electrodes for accelerating ions whose flight direction has been changed by the orthogonal acceleration unit 242. The flight tube 244 is a cylindrical electrode, and a flight space of ions is defined in the flight tube 244. The reflectron electrode 245 includes a plurality of ring electrodes, and a predetermined voltage is applied to each electrode so as to form a potential gradient in which the potential increases toward the subsequent stage. The ions accelerated by the acceleration electrode 243 and having flown in the flight space defined inside the flight tube 244 turn back and fly by the potential gradient. The ion detector 246 detects ions that have flown back by the potential gradient formed by the reflectron electrode 245.

A control unit 5 includes a storage unit 51. In the storage unit 51, time-of-flight-vs-mass-to-charge-ratio information and applied-voltage information are stored. The time-of-flight-vs-mass-to-charge-ratio information is a set of information describing time required for each of the ions having various mass-to-charge ratios to fly in the flight space in the analysis chamber 24. In addition, the applied-voltage information includes information on the value of the voltage applied to each electrode provided in the mass spectrometer 1, and information on the relationship between the voltage applied from a first power supply 34 or a second power supply 38 to be described later and the set temperature. Furthermore, the storage unit 51 also stores a compound database or the like in which information on measurement conditions (mass-to-charge ratio of precursor ions, value of collision energy, and the like) and analysis methods of each of a plurality of known compounds is recorded.

The control unit 5 also includes a measurement execution unit 52 and an analysis processing unit 53 as functional blocks. The measurement execution unit 52 executes measurement by controlling the operation of each unit by, for example, applying a predetermined voltage to each electrode disposed in the mass spectrometer 1 based on a measurement condition set by a user. The analysis processing unit 53 performs processing such as generating a mass spectrum from the measurement data. An entity of the control unit 5 is, for example, a general personal computer, and functional block described above is embodied by a processor executing a dedicated program installed beforehand. The control unit 5 is also connected with an input unit 6 including a keyboard, a mouse, and the like and a display unit 7 including a liquid crystal display or the like.

Since the mass spectrometry itself performed by the mass spectrometer 1 of the present embodiment is similar to the conventional mass spectrometry, the mass spectrometry will be briefly described below.

First, by performing pretreatment of applying a matrix substance, which is an easily ionized substance, to a surface of the sample placed on the sample plate 12, microcrystals of the matrix substance incorporating molecules of the sample are formed on the surface of the sample. Subsequently, the sample plate 12 on which the pretreated sample is placed is placed on the sample plate holder 13, and the sample plate holder 13 is disposed at the measurement position. Then, when being irradiated with laser light from the laser light source 15, microcrystals of the matrix substance are heated, and sample molecules are detached from the surface and are ionized. Ions generated from sample molecules in the ionization chamber 11 enter the vacuum chamber 20 through the sample introduction unit 3. The ions having entered the vacuum chamber 20 are transported by the ion lens 211 and the ion guide 221, and then enter the quadrupole mass filter 231. In the quadrupole mass filter 231, ions having a predetermined mass-to-charge ratio are selected as precursor ions and are incident on the collision cell 232. The precursor ions incident on the collision cell 232 collide with the molecules of the CID gas introduced into the collision cell 232 and are dissociated, and product ions are generated. The product ions generated in the collision cell 232 are transported by the ion lenses 234 and 241 and are incident on the orthogonal acceleration unit 242. The product ions whose flight direction has been changed to the substantially orthogonal direction in the orthogonal acceleration unit 242 are accelerated by the acceleration electrode 243, then enter the flight space surrounded by the flight tube 244, turn back by the potential gradient formed by the reflectron electrode 245 located at the end of the flight space, and are then detected by the ion detector 246.

The output signals from the ion detector 246 are sequentially stored in the storage unit 51. After completion of the measurement, the analysis processing unit 53 converts the time of flight of each ion into a mass-to-charge ratio on the basis of the time-of-flight-vs-mass-to-charge-ratio information stored in the storage unit 51, and generates mass spectrum data having two axes of the mass-to-charge ratio and the signal intensity.

The mass spectrometer 1 of the present embodiment is characterized by the configuration of the sample introduction unit 3 provided in the partition wall 80 between the ionization chamber 11 and the first intermediate vacuum chamber 21. Hereinafter, the sample introduction unit 3 will be described.

FIG. 2 is a schematic diagram illustrating a configuration of the sample introduction unit 3 when ions generated by the ESI source are subjected to mass spectrometry. The sample introduction unit 3 includes a first pipe (corresponding to the first ion introduction pipe in the present invention) 31, a pipe attachment portion 32 to which the first pipe 31 is attached, a heating element 33 disposed on the outer periphery of the first pipe 31, and the first power supply 34 which supplies power to the heating element 33. As the first pipe 31, for example, stainless steel is used. The central axis of the first pipe 31 is orthogonal to the spray direction of the charged droplets from an ESI probe 111, and ions generated by desolvation from the charged droplet are drawn into the first pipe 31 by the pressure difference between the ionization chamber 11 and the vacuum chamber 20.

FIG. 3 is a schematic diagram illustrating a configuration of the sample introduction unit 3 when ions generated by the atmospheric pressure MALDI source are subjected to mass spectrometry. The sample introduction unit 3 includes the first pipe 31 attached to the pipe attachment portion 32, a pipe connection portion 35, and a second pipe 36 connected to the first pipe 31 by the pipe connection portion 35. Also as the second pipe 36, for example, stainless steel is used. The second pipe 36 and the pipe connection portion 35 are detachable from the first pipe 31. In this manner, by connecting the second pipe 36 to the first pipe 31, the ion introduction pipe is made longer than a case where ions are generated by the ESI source, and the inlet end of the second pipe 36 is disposed in the vicinity of the sample on the sample plate 12. The first pipe 31 and the second pipe 36 correspond to the second ion introduction pipe in the present invention, and the second pipe 36 corresponds to a portion of the second ion introduction pipe, the portion being extended from the first ion introduction pipe toward the ionization section, in the present invention. As described above, by using the ion introduction pipe that is longer than that when the ESI source is used, the inlet end of the ion introduction pipe can be brought close to the sample surface, and more ions emitted from the sample can be introduced from the ion introduction pipe (the second pipe 36 and the first pipe 31) into the mass spectrometry section. Here, the ion introduction pipe for the atmospheric pressure MALDI source is configured by connecting the first pipe 31 and the second pipe 36 by the pipe connection portion 35, but one long ion introduction pipe may be used.

The heating element 33 schematically indicated by a heater wire is attached to the outer periphery of the first pipe 31, and the first pipe 31 is heated by supplying power from the first power supply 34 to the heating element 33. Although schematically illustrated by the heater wires in FIGS. 2 and 3, various devices capable of heating the first pipe 31 can be used, and for example, a cartridge heater (block heater or the like), a micro sheath heater, a ceramic coating, and the like can be used as the heating element 33. Alternatively, the first pipe 31 may be heated by irradiation with infrared light or the like.

Similarly, a heating element (corresponding to the heating unit in the present invention) 37 schematically indicated by the heater wire is attached to the outer periphery of the second pipe 36, and the second pipe 36 is heated by supplying power from the second power supply 38 to the heating element 37. The heating element 37 and the second power supply 38 correspond to the heating unit in the present invention. Various methods can also be used for heating the second pipe 36, and for example, the second pipe 36 can be heated by using the heating element 37 including the various heaters described above and the second power supply 38, or by being irradiated with infrared light.

In the mass spectrometer 1 of the present embodiment, the heating element 37 which heats the second pipe 36 is disposed so as to heat an end (end on the ionization chamber 11 side) of the second pipe 36. Preferably, the heating element 37 is disposed so as to surround the tip of the second pipe 36 or the outer periphery of the vicinity of the second pipe 36.

In a conventional mass spectrometer, when ions generated by the atmospheric pressure MALDI source are subjected to mass spectrometry, only a second pipe is connected to a first pipe to extend the ion introduction pipe, but in this case, ions cannot be measured with sufficient sensitivity in some cases. Various factors are conceivable for this, but it is conceivable that since only the first pipe is heated and the second pipe is not heated and is at a low temperature, for example, the molecules of the matrix substance applied at the time of pretreatment of the sample are not desorbed from the ions of the sample molecules, or the ions derived from the sample lose energy due to collision with low-temperature gas molecules and adhere to the ion introduction pipe and disappear.

On the other hand, in the mass spectrometer 1 of the present embodiment, the heating element 37 which heats the second pipe 36 is disposed. Therefore, not only the first pipe 31 but also the second pipe 36 is sufficiently heated. As described later with reference to the measurement results, by heating the second pipe 36, ions can be detected with higher sensitivity than before.

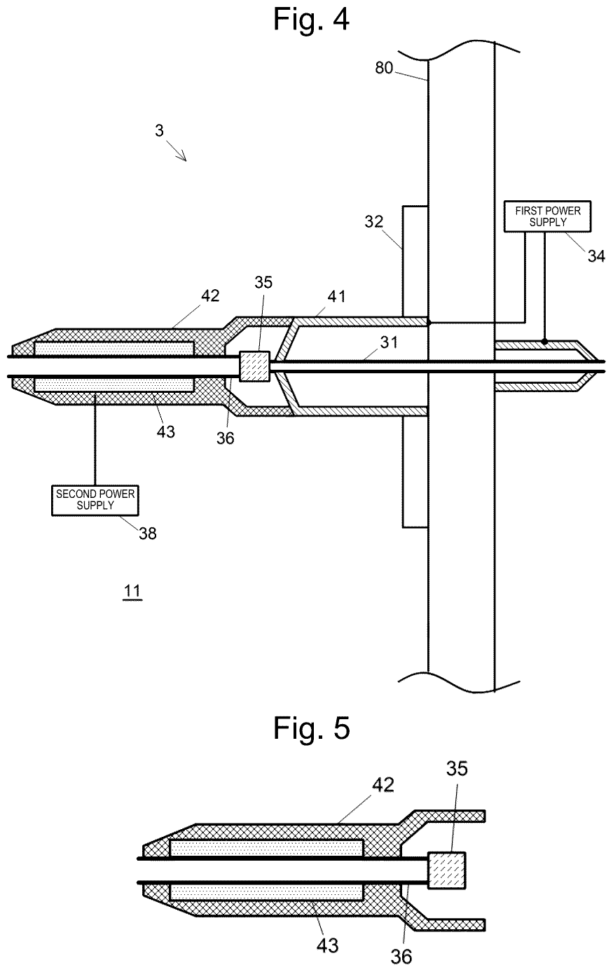

Next, a measurement result confirming that sensitivity of ion detection by heating the second pipe 36 is improved in the mass spectrometer 1 of the present embodiment will be described. Here, as illustrated in FIG. 4, a first pipe attachment member 41 is disposed on the outer periphery of the first pipe 31, and a second pipe attachment member 42 is disposed on the outer periphery of the second pipe 36. Both the first pipe attachment member 41 and the second pipe attachment member 42 are made of stainless steel having conductivity. The first pipe attachment member 41 and the second pipe attachment member 42 are detachable. The first power supply 34 is connected to the first pipe attachment member 41. When the first pipe attachment member 41 and the first pipe 31 are energized from the first power supply 34, the first pipe 31 having a large electric resistance generates heat. Inside the second pipe attachment member 42, a cartridge heater 43 is disposed along the outer periphery of the second pipe 36. When a voltage is applied from the second power supply 38 to the cartridge heater 43, the cartridge heater 43 generates heat to heat the second pipe 36.

In the sample introduction unit 3 of the configuration example of FIG. 4, portions illustrated in FIG. 5 (pipe connection portion 35, second pipe 36, second pipe attachment member 42, and cartridge heater 43) can be attached and detached. Therefore, when the ESI source and the atmospheric pressure MALDI source are replaced, it is only necessary to attach and detach the members illustrated in FIG. 5, and it is not necessary to detach the first pipe 31 attached to the partition wall 80 by the pipe attachment portion 32.

In addition, in the configuration example illustrated in FIG. 4, the second pipe 36 and the cartridge heater 43 (the second pipe attachment member 42 including them) are configured separately, and both are detachable. Therefore, when a sample component adheres to the inside of the second pipe 36 or the second pipe 36 is clogged, the second pipe 36 can be removed alone and cleaned or replaced. In addition, when a problem such as disconnection occurs in the cartridge heater 43, the cartridge heater 43 can be replaced alone. As a result, the cost can be reduced as compared with a case where the second pipe 36 and the cartridge heater 43 (the second pipe attachment member 42 including them) integrated with each other are replaced.

First, as Comparative Example (without heating of the tip), the first pipe 31 was heated to 250 °C by energization from the first power supply 34, and the temperature of the second pipe 36 was measured. In addition, as Example (with heating of the tip), in addition to the heating of the first pipe 31, the second pipe 36 was heated to 450 °C by the cartridge heater 43, and the temperature of the second pipe 36 was measured. Note that the length of the second pipe 36 used in these measurements is 50 mm.

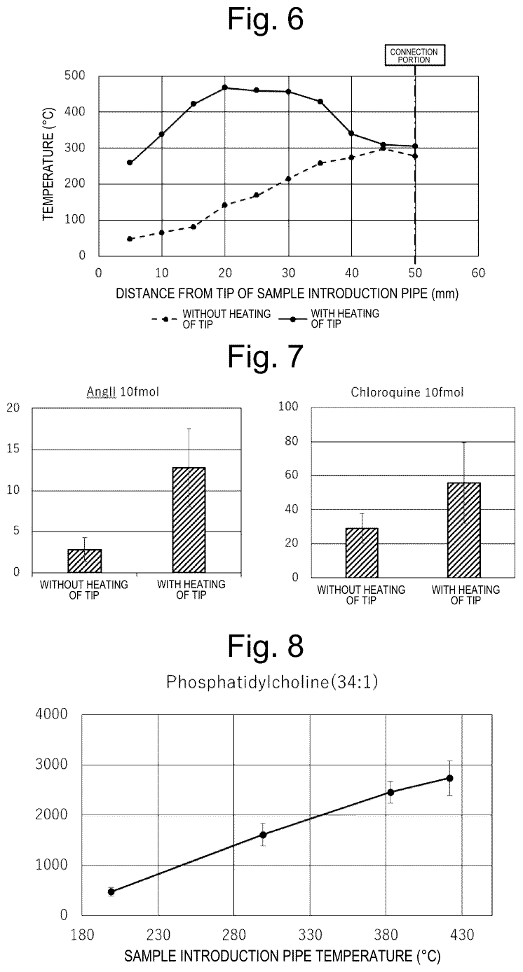

As the measurement result is shown in FIG. 6, in Example (with heating of the tip), the entire second pipe 36 is higher in temperature than Comparative Example. In particular, in the tip portion of the second pipe 36 on the ionization chamber side, the temperature is as high as 200 °C or more as compared with Comparative Example (about 50 °C).

In addition, ions generated from AngII (angiotensin II) and Chloroquine were measured for each of Comparative Example and Example. As shown in FIG. 7, for both of the ions, the measured intensity was higher in Example in which the heating of the tip was performed than in Comparative Example in which the heating of the tip was not performed.

Furthermore, measurement was also performed to examine the relationship between the heating temperature and the measured intensity at the time of heating the tip as in Example. In the measurement, a mouse brain section (mouse brain) was used as a sample, and m/z=798.54 ions (Phosphatidylcholine (34:1)) generated from the section were measured.

As shown in FIG. 8, the maximum heating temperature (the heating temperature of the second pipe 36) at the tip in the measurement was about 430 °C, but at least up to this temperature, the higher the heating temperature, the higher the measured intensity of ions. Although it is necessary to consider thermal resistance of the sample, it is conceivable that the measurement sensitivity of ions is improved as the second pipe 36 is heated to a high temperature at least up to higher than 400 °C. Note that, although depending on the material of the second pipe 36, the upper limit of the heating temperature of the second pipe 36 is appropriately set to about 500 °C in consideration of heat resistance or the like.

The above-described embodiment and the configuration of the device used in actual measurement are merely examples, and can be appropriately modified in accordance with the spirit of the present invention.

In the above-described embodiment and Example, the atmospheric pressure MALDI source and the ESI source are used as the ion source, but another laser ion source (for example, SALDI source) can also be used instead of the atmospheric pressure MALDI source. In addition, instead of the ESI source, an APCI source or a DUIS including both the ESI source and the APCI source can also be used.

In the above-described embodiment and Example, the ion introduction pipe for the atmospheric pressure MALDI source is configured by connecting the second pipe 36 as an extension pipe to the first pipe 31 which is an ion introduction pipe for the ESI source. However, one ion introduction pipe longer than the ion introduction pipe for the ESI source may be used as an ion introduction pipe for the atmospheric pressure MALDI source.

In addition, in the above-described embodiment, the configuration in which the first pipe 31 and the second pipe 36 are heated has been described, but it is also effective to provide a means for suppressing heat release in addition to the heating unit. Specifically, a heat insulating material may be wound around the outer periphery of the first pipe 31 and/or the second pipe 36, or a reflector which reflects thermal radiation from the first pipe 31 and/or the second pipe 36 may be disposed so as to surround the first pipe 31 and/or the second pipe 36.

### Modes

It is obvious for those skilled in the art that the exemplary embodiments described above are specific examples of the following modes.

### Clause 1

One mode of the present invention is a mass spectrometer in which a first ion source configured to spray and ionize a liquid sample in an atmospheric pressure and a second ion source configured to irradiate a sample with laser light and ionize the sample in an atmospheric pressure are alternatively attached as an ionization section, the mass spectrometer including:
a mass spectrometry section which is provided in a vacuum chamber connected to the ionization section via a partition wall and is configured to separate and detect ions generated in the ionization section according to a mass-to-charge ratio;
a first ion introduction pipe which is provided to penetrate the partition wall and is configured to introduce the ions generated in the ionization section into the vacuum chamber, the first ion introduction pipe being used when the first ion source is used;
a second ion introduction pipe which is provided to penetrate the partition wall and is configured to introduce the ions generated in the ionization section into the vacuum chamber, the second ion introduction pipe being longer than the first ion introduction pipe, and being used when the second ion source is used; and
a heating unit configured to heat a portion of the second ion introduction pipe, the portion being located closer to the ionization section than the first ion introduction pipe.

The mass spectrometer according to Clause 1 is a mass spectrometer in which a first ion source configured to spray and ionize a liquid sample in an atmospheric pressure and a second ion source configured to irradiate a sample mixed or coated with a matrix substance with laser light and ionize the sample in an atmospheric pressure are alternatively attached as an ionization section. The first ion source configured to spray and ionize the liquid sample is, for example, an ESI source, an APCI source, or a DUIS including both the ESI source and the APCI source. The second ion source configured to irradiate the sample mixed or coated with the matrix substance with the laser light and ionize the sample in the atmospheric pressure is, for example, an atmospheric pressure MALDI source.

When the ion introduction pipe used in the ESI source or the APCI source is used as it is in using the atmospheric pressure MALDI source, the distance from the inlet end of the ion introduction pipe to the measurement point longer, and the efficiency of taking ions into the ion introduction pipe deteriorates. Therefore, in the mass spectrometer according to Clause 1, when the second ion source is used, the second ion introduction pipe which is longer than the first ion introduction pipe used when the first ion source is used is used. According to findings obtained by the present inventors, conventionally, the reason why ions cannot be measured with sufficient sensitivity when using the second ion introduction pipe is that a portion of the second ion introduction pipe, the portion being located closer to the ionization section than the first ion introduction pipe, is not heated and is at low temperature. In the mass spectrometer according to Clause 1, a portion of the second ion introduction pipe, the portion being located closer to the ionization section than the first ion introduction pipe, is heated by the heating unit, so that the ion measurement sensitivity can be improved as compared with the conventional measurement.

### Clause 2

A mass spectrometer according to Clause 2 is the mass spectrometer according to Clause 1,
wherein the second ion introduction pipe includes the first ion introduction pipe and an extension pipe connected to the first ion introduction pipe.

### Clause 3

A mass spectrometer according to Clause 3 is the mass spectrometer according to Clause 1,
wherein the second ion introduction pipe is configured by one pipe.

The second ion introduction pipe in the mass spectrometer of Clause 1 may be one ion introduction pipe having a length in which the end on the ionization section side is located close to the irradiation position of the laser light on the sample surface as in the mass spectrometer of Clause 3, or may have a first ion introduction pipe and a second pipe detachably connected to the first ion introduction pipe as in the mass spectrometer of Clause 2. In the mass spectrometer of Clause 2, the extension pipe is connected while the first ion introduction pipe penetrating the partition wall is attached, so that the second ion introduction pipe can be easily configured.

### Clause 4

A mass spectrometer according to Clause 4 is the mass spectrometer according to any one of Clause 1 to Clause 3,
wherein the heating unit includes a heating element which is provided so as to surround the second ion introduction pipe and is configured to generate heat by energization.

In the mass spectrometer of Clause 4, the second ion introduction pipe is heated to a higher temperature by heating the ion introduction pipe with the heating element configured to generate heat by energization, so that the measurement sensitivity of ions can be improved.

### Clause 5

A mass spectrometer according to Clause 5 is the mass spectrometer according to Clause 4,
wherein the heating element and the second ion introduction pipe are separately configured and detachable from each other.

In the mass spectrometer according to Clause 5, when a sample component adheres to the inside of the second ion introduction pipe or the second ion introduction pipe is clogged, the second ion introduction pipe can be removed alone and cleaned or replaced. In addition, when a problem such as disconnection occurs in the heating element, the heating element can be replaced alone. Therefore, the cost can be reduced as compared with the case where both the second ion introduction pipe and the heating element are replaced.

### REFERENCE SIGNS LIST

1 . . . Mass Spectrometer
11 . . . Ionization Chamber
111 . . . ESI Probe
12 . . . Sample Plate
13 . . . Sample Plate Holder
14 . . . Moving Mechanism
15 . . . Laser Light Source
16 . . . Mirror
17 . . . Lens
18 . . . Optical Microscope
20 . . . Vacuum Chamber
21 . . . First Intermediate Vacuum Chamber
211 . . . Ion Lens

212 . . . Skimmer
22 . . . Second Intermediate Vacuum Chamber
221 . . . Ion Guide
23 . . . Third Intermediate Vacuum Chamber
231 . . . Quadrupole Mass Filter
232 . . . Collision Cell
233 . . . Multipole Ion Guide
234 . . . Ion Lens
24 . . . Analysis Chamber
241 . . . Ion Lens
242 . . . Orthogonal Acceleration Unit
2421 . . . Expulsion Electrode
2422 . . . Attraction Electrode
243 . . . Acceleration Electrode
244 . . . Flight Tube
245 . . . Reflectron Electrode
246 . . . Ion Detector
3 . . . Sample Introduction Unit
31 . . . First Pipe
32 . . . Pipe Attachment Portion
33 . . . Heating Element
34 . . . First Power Supply
35 . . . Pipe Connection Portion
36 . . . Second Pipe
37 . . . Heating Element

38 . . . Second Power Supply

41 . . . First Pipe Attachment Member
42 . . . Second Pipe Attachment Member

43 . . . Cartridge Heater
5 . . . Control Unit

51 . . . Storage Unit

52 . . . Measurement Execution Unit
53 . . . Analysis Processing Unit
6 . . . Input Unit
7 . . . Display Unit
80 . . . Partition Wall
C . . . Ion Optical Axis

1. A mass spectrometer in which a first ion source configured to spray and ionize a liquid sample in an atmospheric pressure and a second ion source configured to irradiate a sample with laser light and ionize the sample in an atmospheric pressure are alternatively attached as an ionization section, the mass spectrometer comprising:
a mass spectrometry section which is provided in a vacuum chamber connected to the ionization section via a partition wall and is configured to separate and detect ions generated in the ionization section according to a mass-to-charge ratio;
a first ion introduction pipe which is provided to penetrate the partition wall and is configured to introduce the ions generated in the ionization section into the vacuum chamber, the first ion introduction pipe being used when the first ion source is used;
a second ion introduction pipe which is provided to penetrate the partition wall and is configured to introduce the ions generated in the ionization section into the vacuum chamber, the second ion introduction pipe being longer than the first ion introduction pipe, and being used when the second ion source is used; and
a heating unit configured to heat a portion of the second ion introduction pipe, the portion being located closer to the ionization section than the first ion introduction pipe.

2. The mass spectrometer according to claim 1, wherein the second ion introduction pipe includes the first ion introduction pipe and an extension pipe connected to the first ion introduction pipe.

3. The mass spectrometer according to claim 1, wherein the second ion introduction pipe is configured by one pipe.

4. The mass spectrometer according to claim 1, wherein the heating unit includes a heating element which is provided so as to surround the second ion introduction pipe and is configured to generate heat by energization.

5. The mass spectrometer according to claim 4, wherein the heating element and the second ion introduction pipe are separately configured and detachable from each other.
